(19) United States
(12) Patent Application Publication
(10) Pub. No.: US 2006/0012589 A1
(43) Pub. Date: Jan. 19, 2006

(54) METHOD OF MULTIPLE-FRAME SCANS FOR A VIDEO DISPLAY

(76) Inventors: Yao Jen Hsieh, Ping-Tung Hsien (TW); Chih-Sung Wang, Hsin-Chu Hsien (TW)

Correspondence Address: NORTH AMERICA INTELLECTUAL PROPERTY CORPORATION, P.O. BOX 506, MERRIFIELD, VA, 22116, US

(21) Appl. No.: 10/905,058

(22) Filed: Dec. 13, 2004

(30) Foreign Application Priority Data
Jul. 14, 2004 (TW) 093121045

(51) Int. Cl. G09G 5/00

(52) U.S. Cl. 345/204

(57) ABSTRACT

A method of multiple-frame scanns for a display includes generating K line-triggering signals within a period in which one frame is finished completed scanning from a first line to a last line, generating K clocks of different phases for triggering K input data, and displaying K input data on the display according to the K line-triggering signals and the K clocks of different phases.

### BACKGROUND OF INVENTION

1. Field of the Invention

The invention relates to a method of multiple-frame scans, and more particularly, to a method of multi-frame scans for a video display.

2. Description of the Prior Art

For allowing visual enjoyment and for facilitating communication with others or with other systems, the video display has becomes a very popular device recently. There are many kinds of video displays. The liquid crystal display (LCD) is widely used in many portable information products, such as the notebook and the personal digital assistant (PDA), because of its low weight, low power consumption, and low radiation. In addition, the LCD and LCTV have become more and more popular and have replaced the traditional cathode ray tube (CRT) display and CRTTV. But because of the limitations of the liquid crystal's characteristics, when image data changes to another image, the liquid crystal has to be reversed to change the permutation direction. This causes a display delay. In order to quickly switch images, the reaction speed of liquid crystals becomes more important.

In the prior art, in order to solve the above-mentioned display delay problems, a U.S patent application publication U.S. 2002/0109654 discloses an impulse driven LCD. The impulse driven LCD comprises an LCD driving controller for outputting normal data and adjustment data through generating pulses, outputting a first control signal for controlling the normal data and the adjustment data, and outputting a second control signal for controlling image display according to the normal data and the adjustment data. The LCD driving controller comprises a scanning driver for orderly outputting a first scanning signal and a second scanning signal according the second control signal in a displaying time interval. The impulse-driven LCD further comprises an LCD panel for transforming the normal data signal into electric charges stored in capacitors of the LCD panel, and for transforming the adjustment data signal into electric charges stored in capacitors of the LCD panel.

For illustrating the above-mentioned prior art apparatus and method clearly, please refer to FIG. 1. FIG. 1 is a diagram of the impulse driven LCD 500 according to the prior art. The LCD 500 comprises a timing controller 100, a data driver 200, a gate driver 300, and an LCD panel 400. The timing controller 100 receives image data, and outputs the image data to the data driver 200. A plurality of control signals are transferred to the data driver 200 and the gate driver 300 to control stored charges inside the LCD panel.

In addition, the detailed control signal relationship is illustrated in FIG. 2. FIG. 2 is a diagram of internal signals in the LCD 500. In a displaying interval 1 H, the normal data and the adjustment data are completely and simultaneously driven, where the adjustment data is used to compensate black data and white data of the LCD. When the normal data and the adjustment data are outputted from the data driver 200 to the LCD panel 400, the normal data charges from a first horizontal line on the LCD panel 400 according to a control signal of the gate driver 300 so that liquid crystals of the first horizontal line can be correctly controlled. When the normal data of the first horizontal line are completely scanned, the second horizontal line performs the above-mentioned scanning operation. The scanning operation of the normal data are performed continuously for half of the LCD panel 400, and the scanning operation of the adjustment data starts to be performed to scan the first horizontal line. Then, the above-mentioned scanning operation of the adjustment data is performed in order on each horizontal line until the whole panel is scanned. Even when the adjustment data starts to scan, the normal data still scans as well. This means that the normal data and the adjustment data scan simultaneously.

In the prior art, the method for solving display delay problems can simultaneously complete driving the normal data and the adjustment data to improve the display delay and further to raise the response speed of the liquid crystals. But because the signal controlling method of the prior art does not utilize multiple frames of multiple phases for a display, it can not elastically change the time interval between two triggering signals and is not suitable for use with a multiple-frame scanning technique. Therefore the prior art method cannot execute multiple-frames scanning for a display efficiently.

### SUMMARY OF INVENTION

It is therefore one of the objectives of the claimed invention to provide a method of multiple-frame scanning for a display in order to solve the above-mentioned display delay problem.

According to an exemplary embodiment of the claimed invention, a method of multiple-frame scans for a video display is disclosed, where the video display displays a frame comprising M horizontal lines, and the method comprises: generating K line-triggering signals within a period in which one frame completes scanning from a first line to a last line; generating K clocks of different phases for triggering K input data; and displaying K input data on the display according to the K line-triggering signals and the K clocks of different phases.

Furthermore, a displaying system for performing multi-frame scans is disclosed, the displaying system comprises: a display capable of displaying a frame comprising M horizontal lines; a control signal generator for generating K clocks of different phases and K line-triggering signals in a time interval to scan the M horizontal lines; a plurality of line-drivers for controlling the display of the M horizontal lines according to the K line-triggering signals and the K clocks of different phases; and a data output controller electrically connected to the plurality of line-drivers, the data output controller being controlled by the line-drivers for displaying the K input data on the display.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a diagram of an impulse driven LCD according to the prior art.

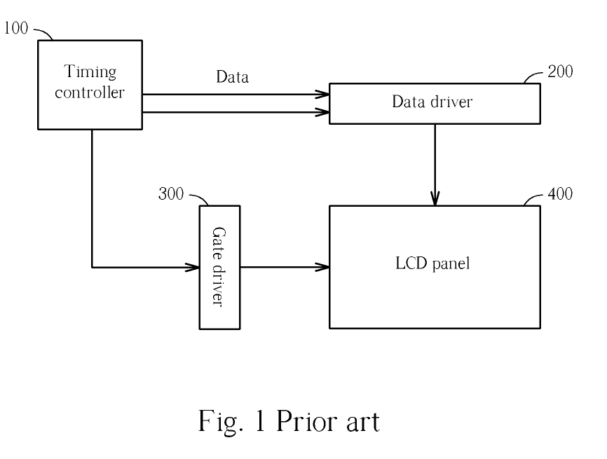

FIG. 2 is a diagram of internal signals in the LCD according to the prior art.

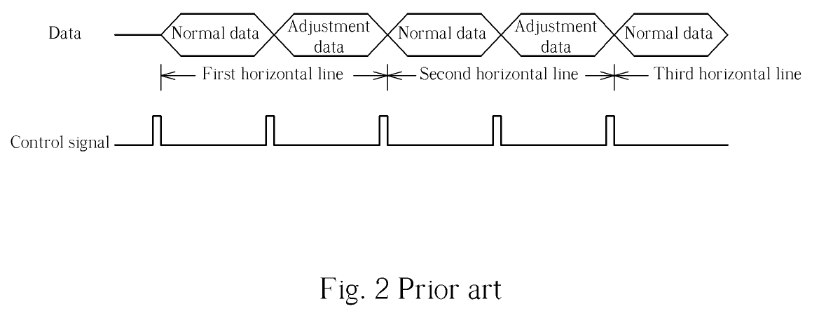

FIG. 3 is a diagram of a displaying system having a multiple-frame scans function according to the present invention.

FIG. 4 is a waveform chart of an embodiment of the displaying system according to the present invention.

FIG. 5 is a diagram of a wave used for controlling three line-drivers of an embodiment according to the present invention.

### DETAILED DESCRIPTION

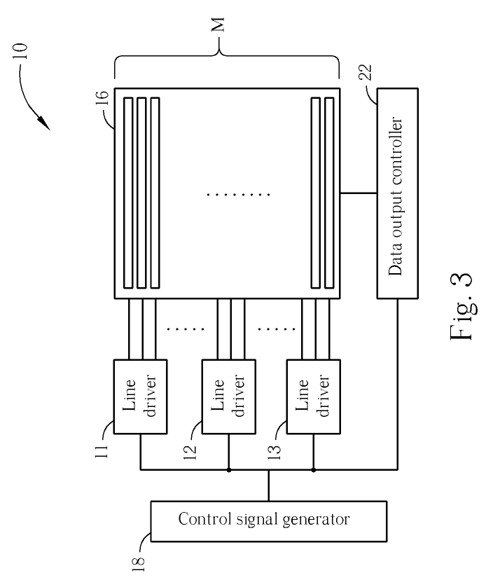

Please refer to FIG. 3, which is a diagram of a displaying system 10 having a multiple-frame scans function according to the present invention. The displaying system 10 comprises a plurality of line-drivers 11, 12, and 13, a display 16, a control signal generator 18, and a data output controller 22. The display 16 comprises a plurality of horizontal lines (M lines are shown in FIG. 3). Each line comprises a plurality of pixels. All pixels of all lines can be driven to display a whole frame according to displaying data. The display method of the display 16 involves scanning the first line, displaying the pixels of the first line, and then orderly scanning the second line, displaying the pixels of the second line, scanning the third line, and so on. At last the M^{th} line is scanned. The line scan operation of the display 16 is controlled by a plurality of line drivers. In this embodiment shown in FIG. 3, the line drivers 11, 12, and 13 respectively control parts of horizontal lines of the display 16, which are the first ⅓ horizontal lines, the middle ⅓ horizontal lines, and the last ⅓ horizontal lines.

The data output controller 22 is electrically connected to the line drivers 11, 12, and 13 for outputting the display data to the display 16 in order to display all pixels on a horizontal line. In a detailed illustration, the data output controller 22 is controlled by the line drivers 11, 12, 13 to output display data to the display 16 in the line scan operation. In the line scan operation, each horizontal line scan timing and each line driver is controlled by many control signals to coordinate the timing of multiple-frame scanning. Therefore, the control signal generator 18 is configured to generate these control signals or clock signals. Because the present invention displaying system has the function of multiple-frame scans, the control signal generator 18 has to generate a plurality of line-triggering signals and a plurality of clock signals, which have different phases, in the time of completing scanning M horizontal lines. In other words, if the present invention displaying system is capable of completing 3-frame scanning, it has to complete 3 line scan operations while completing scanning M horizontal lines, and it needs 3 line-triggering signals and 3 clock signals, which have different phases. The control signals generated by the control signal generator 18 are capable of achieving the function of multiple-frame scans. This is also a key point of the present invention.

In addition, the scanning characteristic of the line driver is illustrated as follows:

Assuming that a line driver is configured to control 10 lines, when the line driver starts to scan a first line, the second and the third line will be scanned later. When the 10^{th} line is completely scanned, another line scan operation can be started from the first line. Therefore, for a line driver, the period of the above-mentioned line scan operation has to be longer than the time needed for scanning these lines. For example, if a line driver is configured to controls 300 line and the whole time needed for scanning the 300 lines is 0.3 seconds, the time interval between the first time of scanning the 300 lines and the second time of scanning the 300 lines must be longer than 0.3 seconds. In other words, the time interval between two successive times for scanning the first time is the above-mentioned period of the line scan operation, and the period of the line scan operation must be longer than at least a time needed for scanning all lines. If the present invention displaying system has to execute more multiple-frame scans, the period of the line scan operation corresponding to a line driver has to be shorter. In other words, the lines of the frame need more line drivers for controlling the scanning. Oppositely, the displaying system needs more control signals to drive these line drivers. Therefore, the present invention control signal generator 18 can be configured to generate many of clock signals, which have different phases, to achieve the purpose of many control signals.

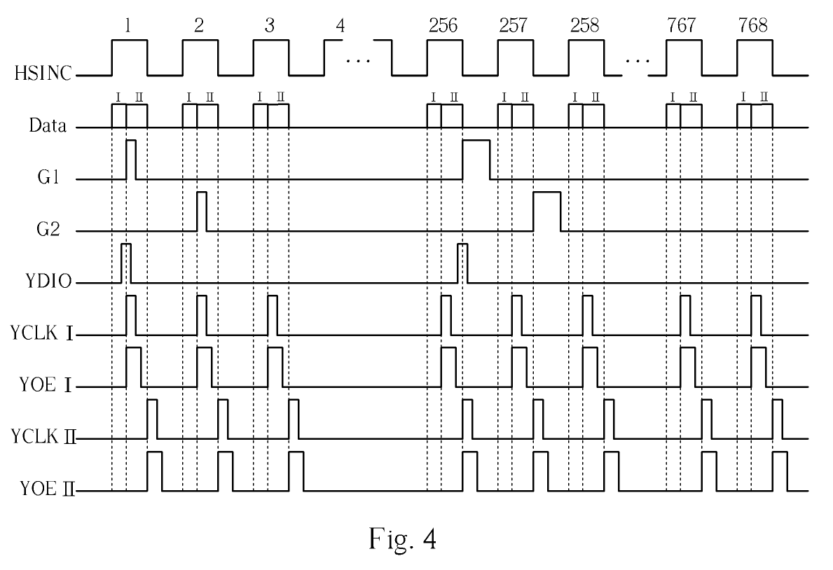

Please refer to FIG. 4, which is a waveform chart of an embodiment of the displaying system according to the present invention. In the embodiment of FIG. 4, the whole frame has 768 lines, where each line comprises 1280 pixels, and the signal HSINC represents the timing of the line scan operation of the displaying system according to the present invention. For example, HSINC 1 represents that the first line is now being scanned, HSINC 2 represents that the second line is now being scanned, and HSINC 768 represents that the 768^{th} line is now being scanned. The signal DATA controls displaying data of a line. In this embodiment, we use 2-frame scanning, therefore, while one line is scanned, there are two displaying data to be processed (for example, the data I and II shown in FIG. 4). Furthermore, the signal G1 represents the timing of scanning the first line, the signal G2 represents the timing of scanning the second line, and other signals G3 to G768 are omitted in FIG. 4 for simplification.

As mentioned above, if the present invention displaying system has to complete K-frame scans, it needs K line-triggering signals and K clock signals, which have different phases, to complete K line-scans operations in the time of scanning the whole frame. In FIG. 4, 2-frame scanning is executed from line 1 to line 768, and the line-triggering signal YDIO has 2 impulses between line 1 and line 768, where one impulse is located on line 1 and the other impulse is located on line 256 (about ⅓ of the whole frame). Please note that the line-triggering signal YDIO is used to trigger the line-scanning operation on line 1. Therefore, when the first impulse (located on line 1) of the line-triggering signal YDIO is triggered, the displaying system starts to scan line 1 to show the first frame. And when the second impulse (located on line 256) of the line-triggering signal YDIO is triggered, the displaying system starts to scan line 1 again to show the second frame. Here, the data I is used to show the first frame, and the data II is used to show the second frame. That is, when the first impulse of the line-triggering signal is triggered, the displaying system utilizes the data I to scan from line 1 in order to show the first frame. Furthermore, when the second impulse of the line-triggering signal is triggered, the displaying system utilizes the data II to scan from line 1 again to show the second frame. In addition, the data I and the data II are respectively shown through two control signals YOEI, YOEII, which have different phases, and the two control signals are controlled by two clock signals YCLK1 and YCLKII, which have different phases. Through these control signals, which have different phases, the data I and the data II can be shown in the time of scanning one line, and the multiple-frame scans is therefore available.

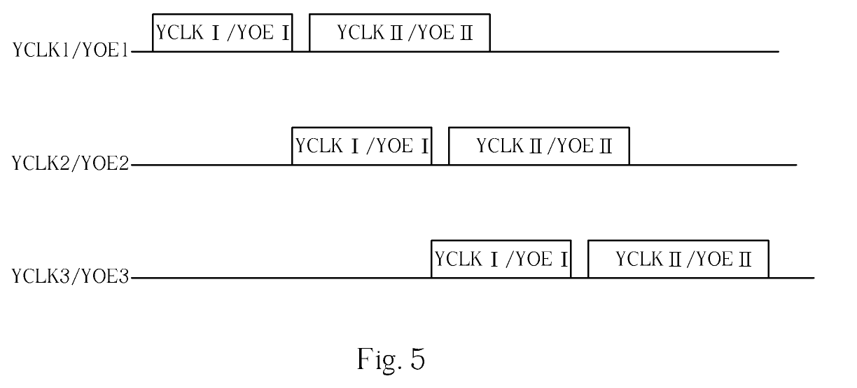

The horizontal lines of the present invention are driven by a plurality of line-drivers. Therefore, each line-driver has to be controlled by each corresponding signal. Please refer to FIG. 5, which is a diagram of a wave used for controlling three line-drivers of an embodiment according to the present invention. The line-driver controlling clock signals YCLK1, YCLK2, YCLK3 are respectively used to control the line-drivers 11, 12, 13. Furthermore, YOE1, YOE2, and YOE3 respectively shows the data driving signals corresponding to the line drivers 11, 12, and 13. First, the signals YCLKI and YOEI utilize the line-driver controlling clock signal YCLK1 to control the line driver 11 to show the data I (shown in FIG. 4) on the display. After the line driver 11 is completely used by the signals YCLKI and YOEI, the signals YCLKI and YOEI utilizes the line-driver controlling clock signal YCLK2 to control the line driver 12 to scan to show the data I. Similarly, after the line driver 12 is completely used by the signals YCLKI and YOEI, the signals YCLKI and YOEI further utilizes the line-driver controlling clock signal YCLK3 to control the line driver 13 to scan to show the data I. In addition, for each line driver, after each line driver has been used by the signal YOEI first, the line driver can be used by the other signal YOEII.

In the embodiment shown in FIG. 4, the line-triggering signal YDIO triggers the first line scan operation on line 1 in signal HSINC1. When the line operation is executed on ⅓ of the whole frame (in the signal HSINC256), the line-triggering signal YDIO triggers the second impulse to trigger the second line scan operation on line 1. The timing of the first line scan operation and the timing of the second line scan operation can be decided according to users' demands. In another embodiment of the present invention, the second scanning operation is triggered when the first scanning operation is executed on ½ of the whole frame (that is the signal HSINC 383). At this time, the data I and the data II occupy the same time on a single line, where the line-triggering signal YDIO determines the triggering timing of each line scan operation.

The present invention is used for multiple-frame scans. In 3-frame scans of another embodiment according to the present invention, 3 data, which are data 1, data II, and data III, are processed at one time needed for scanning all lines. The first line scan operation is triggered in the signal HSINC1. The second line scan operation is triggered when the first operation is executed on the first ⅓ of the whole frame (the signal HSINC 256). Furthermore, the third scanning operation is triggered when the first scanning operation is executed on the second ⅓ of the whole frame (the signal HSINC 512). Because the three scanning operations are performed to show three data, other control signals YCLKIII, YOEIII (not shown), which have different phases from other control signals YCLKI, YOEI, YCLKII, YOEII, are needed. That is, each line driver controlling signal YCLK1, YCLK2, and YCLK3 is first used to show the data I through the control signal YCLK/YOEI, then is used to show the data II through the control signal YCLKII/YOEII, and at last is used to show the data III through the control signal YCLKIII/YOEIII. For a higher number of multiple-frame scanning, the signal YDIO needs to be changed. That is, more impulses of the signal YDIO are used to trigger the above-mentioned line-scanning operation. And furthermore, other control signals, for example, YCLKIV/YOEIV and YCLKV/YOEV (not shown) also have to be used so that the present invention purpose of the multiple-frame scans is achieved.

In the prior art, for solving the problem of display delay, although the prior art is capable of simultaneously completely driving the normal data and the adjustment data in a displaying time 1 H in order to improve the response speed of liquid crystals, the prior art cannot flexibly change the time interval between two triggering signals and cannot be used for multiple-frame scans because the prior art does not utilize signals, which have different phases. In contrast to the prior art, the present invention utilizes a control signal generator to generate K clock signals, which have different phases, and the present invention generates K line-triggering signals in the time of scanning M lines in order to achieve the purpose of K-frame scans (this means that there are K data to be shown). Furthermore, the present invention has a plurality of line drivers to control the line scan operation on all lines of the whole frame according to the line driver controlling signals, which are generated by the data output controller and corresponding to each line driver. This allows the time interval between two scanning operations to be flexibly adjusted. Therefore, the present invention not only has the function of multiple-frame scans, but also has the advantages of improving response speed of the liquid crystal display, allowing the display to display more clearly, and flexibly adjusting the time interval between two line scan operations of the multiple-frame scans.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of multiple-frame scans for a video display, the video display displaying a frame comprising M horizontal lines, the method comprising:
(a) generating K line-triggering signals within a period in which one frame completes scanning from a first line to a last line;
(b) generating K clocks of different phases for triggering K input data; and
(c) displaying K input data on the display according to the K line-triggering signals and the K clocks of different phases.

2. The method of claim 1, wherein the step (c) comprises consecutively displaying the K input data from an initial horizontal line on the M horizontal lines when the input data is triggered by a corresponding line-triggering signals.

3. A displaying system for performing multi-frame scans, the displaying system comprising:
a display capable of displaying a frame comprising M horizontal lines;
a control signal generator for generating K clocks of different phases and K line-triggering signals in a time interval to scan the M horizontal lines;
a plurality of line-drivers for controlling the display of the M horizontal lines according to the K line-triggering signals and the K clocks of different phases; and
a data output controller electrically connected to the plurality of line-drivers, the data output controller being controlled by the line-drivers for displaying the K input data on the display.

4. The displaying system of claim 3, wherein each line-driver is adapted to control non-overlapping parts of the M horizontal lines.

5. The displaying system of claim 3, wherein the control signal generator is configured to generate a plurality of driver controlling clocks for controlling the line-drivers.

6. The displaying system of claim 5, wherein each line-driver is further configured to generate driver controlling clocks corresponding to the line-drivers according to the control signal generator for controlling the non-overlapping parts of the M horizontal lines.

7. The displaying system of claim 5, wherein the plurality of driver controlling clocks comprise the K clocks of different phases.

8. The displaying system of claim 3, wherein the display is a liquid crystal display (LCD).

9. The displaying system of claim 3, wherein the display is an organic light emitting diode (OLED).
